(19) United States
(12) Patent Application Publication
(10) Pub. No.: US 2002/0002844 A1
(43) Pub. Date: Jan. 10, 2002

(54) Press die for press forming of glass

(76) Inventors: Jun Masuda, Numazu-shi (JP); Toshihisa Kamano, Numazu-shi (JP)

Correspondence Address: Pillsbury Winthrop LLP, East Tower, Ninth Floor, 1100 New York Avenue, Washington, DC, 20005-3918, US

(21) Appl. No.: 09/867,420

(22) Filed: May 31, 2001

(30) Foreign Application Priority Data
Jun. 5, 2000 (JP) 2000-167921
Sep. 14, 2000 (JP) 2000-280486

(51) Int. Cl. C03B 11/06; C03B 1/00

(52) U.S. Cl. 65/374.11

(57) ABSTRACT

The object of this invention is to provide a press die for press forming of glass, which is capable of preventing the generation of interdiffusion between a matrix material of press die and a releasing film, making it possible to retain the excellent releasability of the releasing film for a long period of time. Matrix body is covered by a diffusion preventive film, which in turn is covered with a releasing film. In this example, the matrix body is constituted by a sintered body of tungsten carbide (WC) containing 3 wt% of titanium carbide and none of metal-based binder, the diffusion preventive film is constituted by a sputtered film of niobium (Nb) 0.05 micrometer in thickness, and the releasing film is constituted by a sputtered film of an alloy consisting of platinum (Pt) and iridium (Ir) 0.3 micrometer in thickness. The diffusion preventive film may be a high-melting point metal such as Ta, Hf, Zr, Re, Ir, Mo, Rh, Ru or Os other than Nb.

### CROSS-REFERENCE TO RELATED APPLICATIONS

This application is based upon and claims the benefit of priority from the prior Japanese Patent applications No. 2000-167921, filed Jun. 5, 2000; and No. 2000-280486, filed Sep. 14, 2000, the entire contents of both of which are incorporated herein by reference.

### BACKGROUND OF THE INVENTION

This invention relates to a press die to be employed in the press forming of a glass article, and in particular, to materials for a coating film to be applied to the surface of press die.

The press forming method is conventionally extensively employed in the manufacture of an optical element made of glass. According to this method, the raw glass material is heated up near to the transition temperature thereof, and then, the heated glass material is pressed with a press die, thereby transferring the pattern of the press die to the glass. The press die to be employed in the press forming is required to have such specific features that the surface thereof can be mirror-finished, the strength at elevated temperature thereof is high, and the glass releasability thereof is excellent.

Thus, the press die which is generally employed is composed of a tungsten carbide sintered body whose surface is covered by a releasing film made of a noble metal highly resistant to oxidation. Further, cobalt or nickel is commonly employed as a binder for the tungsten carbide sintered body. When any of these binder metals is repeatedly heated on the occasion of press forming, the binder metals diffuse into the noble metal constituting the releasing film. As a result, the composition of the releasing film changes, tarnishing the surface of press die. With the development of the tarnishing of the surface of press die, fused glass is enabled to be easily adhered onto the surface of press die. Thus, the diffusion of these binder metals into the releasing film is considered as being one of the reasons for the short life of the press die to be employed for the press forming of glass.

With a view to solve this problem, Jpn. Pat. Appln. KOKAI Nos. 7-2533 and 10-194754 set forth a press die for press forming of glass wherein a tungsten carbide sintered body containing no metal-based binder is employed. In this manner, when a press die is manufactured by making use of a tungsten carbide sintered body which is free from the metal-based binder, the binder metal is prevented from diffusing into the releasing film.

However, even if a tungsten carbide which is free from the metal-based binder is employed as a matrix material for the press die, it is still impossible to prevent the interdiffusion between the tungsten in the matrix material and the releasing film. As a result, the tungsten is permitted to reach the surface of the releasing film through the releasing film, thereby enabling the oxides thereof to be formed. As a result, the surface of press die is caused to tarnish in appearance, and with the development of this tarnishing, the releasability of the press die is deteriorated so as to enable fused glass to be easily adhered onto the surface of press die.

### BRIEF SUMMARY OF THE INVENTION

The present invention has been accomplished in view of the aforementioned problems accompanied with the conventional press die for press forming of glass, and therefore, the object of this invention is to provide a press die useful for the press forming of glass, which is capable of preventing the generation of interdiffusion between a matrix material of the press die and a releasing film, thereby making it possible to retain the excellent releasability of the releasing film for a long period of time.

Namely, this invention provides a press die for press forming of glass, which comprises:

a matrix body;

a diffusion preventive film covering the surface of the matrix body; and

a releasing film covering the surface of the diffusion preventive film;

wherein the diffusion preventive film is provided with function to prevent a principal constituent element in the matrix material from diffusing into the releasing film.

According to this invention, the diffusion preventive film is constituted by a material which enables the principal constituent element in the matrix material (an element which is the largest in weight ratio in the composition of constituent elements) to become very slow in diffusion velocity. Therefore, it is possible, according to this invention, to prevent the denaturing of the releasing film that might be otherwise resulted from the diffusion of the principal constituent element of the matrix material, thereby making it possible to retain the excellent releasability of the releasing film for a long period of time.

This diffusion preventive film can be constituted by a high-melting point metal having a melting point, as represented by centigrade, of not less than 2.6 times as high as the forming temperature of glass.

The diffusion preventive film may be constituted by a plurality of layers differing in composition from each other in conformity with the matrix material of press die and with the material of the releasing film.

Preferably, the diffusion preventive film has a thermal expansion coefficient falling between the thermal expansion coefficient of the matrix material of press die and the thermal expansion coefficient of the releasing film.

In the case where the matrix material is constituted by a sintered body of tungsten carbide (WC), the diffusion preventive film can be constituted by at least one kind of metal selected from the group consisting of Ta, Nb, Re, Os, Ru, Ir, Zr, Mo, Rh and Hf.

By the way, if the diffusion preventive film itself is provided with an excellent releasability, the deposition thereon of an additional releasing film would be no longer required.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a cross-sectional view illustrating one example of the structure of surface region of the press die for press forming of glass according to the this invention; and

FIG. 2 is a graph illustrating a pattern of the program control of press forming of glass, which has been employed in a comparison test.

### DETAILED DESCRIPTION OF THE INVENTION

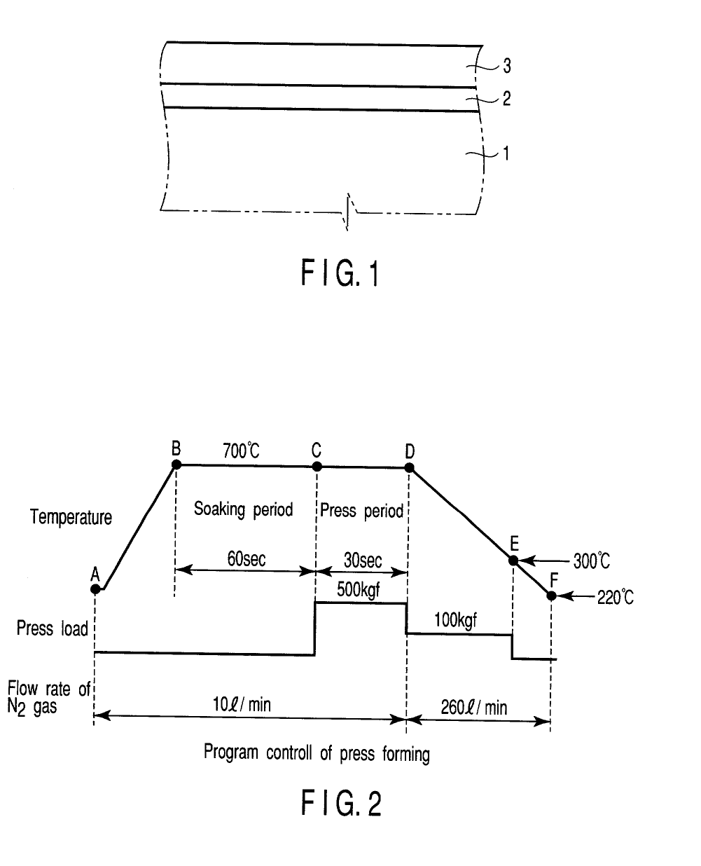

Next, this invention will be explained with reference to FIG. 1 illustrating one example of the structure of surface region of the press die to be employed for the press forming of glass according to the this invention. As shown in FIG. 1, the surface of matrix body 1 is covered by a diffusion preventive film 2, which in turn is convered with a releasing film 3. In this example, the matrix body 1 is constituted by a sintered body of tungsten carbide (WC), the diffusion preventive film 2 is constituted by a sputtered film of niobium (Nb), and the releasing film 3 is constituted by a sputtered film of an alloy consisting of platinum (Pt) and iridium (Ir).

By the way, the materials for the diffusion preventive film 2 can be constituted, other than niobium (Nb), by zirconium (Zr), ruthenium (Ru), hafnium (Hf), tantalum (Ta), rhenium (Re), osmium (Os), molybdenum (Mo), rhodium (Rh) or iridium (Ir), or an alloy of these elements.

Samples of press die for press forming of glass, each sample bearing thereon a different kind of the diffusion preventive film 2, were prepared and the performances thereof were compared with each other. By the way, the press die is of a disk-shaped configuration having a diameter of 34 mm and a thickness of 7.5 mm. The matrix body 1 is made of a sintered body of tungsten carbide (WC) and contains 3 wt% of titanium carbide (TiC) but is free from any metallic binder (such as nickel, cobalt, etc.). The surface of the matrix body 1 is mirror-finished, on which the diffusion preventive film 2 and the releasing film 3 are formed as described below. Namely, the following six kinds of press die (including one kind of conventional press die for the purpose of comparison) were manufactured.

### SAMPLE A

Niobium (Nb) was deposited on the surface of the matrix body 1 to a thickness of 0.05 μm by means of sputtering method to form the diffusion preventive film 2. Thereafter, an alloy consisting of platinum (Pt) and iridium (Ir) (Pt: 40 wt%, Ir: 60 wt%) was deposited on the surface of the diffusion preventive film 2 to a thickness of 0.3 μm by means of sputtering method to form the releasing film 3.

By the way, the parameters involved in this case were as follows:

| Melting point of Nb: | 2469° C. |
|---|---|
| Melting point of Pt—Ir alloy: | 2176° C. |
| Forming temperature: | 700° C. |
| Melting point of Nb/forming temperature: | 3.5 |
| Melting point of Pt—Ir alloy/forming temperature: | 3.1 |

### SAMPLE B

Molybdenum (Mo) was deposited on the surface of the matrix body 1 to a thickness of 0.05 μm by means of sputtering method to form the diffusion preventive film 2. Thereafter, an alloy consisting of platinum (Pt) and iridium (Ir) (Pt: 40 wt%, Ir: 60 wt%) was deposited on the surface of the diffusion preventive film 2 to a thickness of 0.3 gm by means of sputtering method to form the releasing film 3.

By the way, the parameters involved in this case were as follows:

| Melting point of Mo: | 2623° C. |
|---|---|
| Melting point of Pt—Ir alloy: | 2176° C. |
| Forming temperature: | 700° C. |
| Melting point of Nb/forming temperature: | 3.7 |
| Melting point of Pt—Ir alloy/forming temperature: | 3.1 |

### SAMPLE C

Hafnium (Hf) was deposited on the surface of the matrix body 1 to a thickness of 0.02 μm by means of sputtering method, and then, niobium (Nb) was deposited on the surface of the resultant hafnium layer to a thickness of 0.03 μm by means of sputtering method to thereby form the diffusion preventive film 2 consisting of a 2-ply layer. Thereafter, an alloy consisting of platinum (Pt) and iridium (Ir) (Pt: 40 wt%, Ir: 60 wt%) was deposited on the surface of the diffusion preventive film 2 to a thickness of 0.3 μm by means of sputtering method to form the releasing film 3.

By the way, the parameters involved in this case were as follows:

| Melting point of Hf: | 2231° C. |
|---|---|
| Melting point of Nb: | 2469° C. |
| Melting point of Pt—Ir alloy: | 2176° C. |
| Forming temperature: | 700° C. |
| Melting point of Hf/forming temperature: | 3.2 |
| Melting point of Nb/forming temperature: | 3.5 |
| Melting point of Pt—Ir alloy/forming temperature: | 3.1 |

### SAMPLE D

Tantalum (Ta) was deposited on the surface of the matrix body 1 to a thickness of 0.05 μm by means of sputtering method to form the diffusion preventive film 2. Thereafter, an alloy consisting of rhenium (Re) and iridium (Ir) (Re: 50 wt%, Ir: 50 wt%) was deposited on the surface of the diffusion preventive film 2 to a thickness of 0.3 μm by means of sputtering method to form the releasing film 3.

By the way, the parameters involved in this case were as follows:

| Melting point of Ta: | 3020° C. |
|---|---|
| Melting point of Re/Ir alloy: | 2805° C. |
| Forming temperature: | 700° C. |
| Melting point of Ta/forming temperature: | 4.3 |
| Melting point of Re/Ir alloy/forming temperature: | 4.0 |

### SAMPLE E

Ions of rhenium (Re) and iridium (Ir) were implanted into the surface of the matrix body 1 by means of ion-implantation method (40-10 keV; at a concentration of: 5×10¹⁷ ions/cm², respectively). Thereafter, an alloy consisting of rhenium (Re) and iridium (Ir) (Re: 50 wt%, Ir: 50 wt%) was deposited on the surface of the matrix body 1 to a thickness of 0.3 μm by means of sputtering method to form a diffusion preventive film functioning also as the releasing film 3.

By the way, the parameters involved in this case were as follows:

| Melting point of Re/Ir alloy: | 2805° C. |
|---|---|
| Forming temperature: | 700° C. |
| Melting point of Re/Ir alloy/forming temperature: | 4.0 |

### SAMPLE F

Prior Art

For the purpose of comparison, a press die according to the conventional method was manufactured under the following conditions. First of all, nickel (Ni) was deposited on the surface of the matrix body 1 to a thickness of 0.05 μm by means of sputtering method to thereby form an intermediate film (the diffusion preventive film 2). Thereafter, an alloy consisting of platinum (Pt) and iridium (Ir) (Pt: 40 wt%, Ir: 60 wt%) was deposited on the surface of the diffusion preventive film 2 to a thickness of 0.3 μm by means of sputtering method to form the releasing film 3.

By the way, the parameters involved in this case were as follows:

| Melting point of Ni: | 1455° C. |
|---|---|
| Melting point of Pt—Ir alloy: | 2176° C. |
| Forming temperature: | 700° C. |
| Melting point of Ni/forming temperature: | 2.1 |
| Melting point of Pt—Ir alloy/forming temperature: | 3.1 |

Then, the press forming of glass optical elements was performed by making use of these press dies obtained as described above, and the effects of these diffusion preventive films 2 were examined. FIG. 2 shows the patterns of the press forming program employed in this case. By the way, the press forming conditions in this case were as follows:

Product name of the glass: BK-7 (Sumita Optical Glass, Inc.)

| | |
|---|---|
| Forming temperature (nitrogen gas atmosphere): | 700° C. |
| Press load (at the time of press forming): | 500 kgf |
| Press load (at the time of cooling): | 100 kgf |
| Duration of press: | 30 seconds |

First of all, for the purpose of suppressing the oxidation of the press die, the press die was heated up to the forming temperature (A→B) while allowing nitrogen gas to flow over the press die at a flow rate of 10 L/min. Then, this temperature of the press die was maintained until the temperature of the glass was increased up to the forming temperature thereof (B→C). As the temperature of the glass was increased up to the forming temperature thereof, the press forming of the glass was performed with a load of 500 kgf, thereby transferring the pattern of the press die to the glass (C→D). Upon finishing the press forming, the flow rate of nitrogen gas was increased to 260 L/min to cool the glass and the press die (D→E) .

In this case, due to reason that the releasing film of press die tends to be easily peeled away if the formed glass is removed from the press die as the temperature of the formed glass is still high, the press die was allowed to cool down to 300° C. while applying a load of 100 kgf. Finally, after the load to the press die was completely removed and the temperature of the press die was allowed to cool down to 220° C., the formed glass was taken out of the press die (E→F).

When the press forming of glass was repeated in the same manner under the aforementioned conditions, all of the Samples A to E were found free from the generation of tarnishing on the surface of press die even after 500 shots of press forming, and no substantial change in releasability of press die was also recognized even after 500 shots of press forming. Whereas, in the case where the Sample F (prior art) was employed in the press forming, the development of tarnishing could be recognized on the surface of press die after a repeated press forming of 5 shots, and also the adhesion of molten glass was recognized after a repeated press forming of 53 shots.

Table 1 shows the results of the tests which were performed on the Samples A and Sample F.

TABLE 1

| | | Melting | | |
|---|---|---|---|---|
| | | point of diffusion | Changes | |
| | | preventive | of press | |
| | Diffusion | film/Press forming | die | Changes in |
| | preventive film | temperature | surface | releasability |
| Sample | Nb | 3.5 | No change | No change |
| A | | | even after | even after |
| | | | 500 shots | 500 shots |
| Sample | Ni | 2.1 | Tarnished | Glass |
| B | | | in white | thermally |
| | | | after 5 | adhered after |
| | | | shots | 53 shots |

When the surface of press die was analyzed by means of X-ray photoelectron spectroscopy after finishing the press forming, oxides of tungsten component constituting the matrix were recognized on the surface of the Sample F (prior art). Whereas, in the case of the Sample A, the generation of tungsten oxide could not be substantially recognized on the surface thereof.

By the way, the diffusion coefficient D(cm²/sec) of tungsten in the metal of the diffusion preventive film (intermediate film) at a given temperature T (° C.) is correlated with the value of Tm/T (Tm: the melting point (° C.) of the metal of the diffusion preventive film (intermediate film)), so that the higher the value of the Tm/T is, the slower the diffusion of tungsten would become. Therefore, as shown in Table 1, in the case of Sample F which is relatively small in the value of Tm/T, tungsten was assumably allowed to diffuse into the metal of the diffusion preventive film in an early stage of the repeated press forming. As a result, tungsten oxides were produced on the surface of the press die, thereby tarnishing the surface thereof in white and hence deteriorating the releasability. Whereas, in the case of Sample A which is relatively large in the value of Tm/T, the diffusion of tungsten into the diffusion preventive film was caused to retard, thereby making it possible to retain the excellent releasability thereof for a long period of time.

According to this invention, it is now possible to prevent main constituent elements of the matrix body from diffusing into the releasing film, thereby making it possible to prolong the life of the press die to be employed in the press forming of glass. As a result, it is possible to reduce the manufacturing cost of glass optical elements.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A press die for press forming of glass, which comprises:
a matrix body;
a diffusion preventive film covering the surface of said matrix body; and
a releasing film covering the surface of said diffusion preventive film;
wherein said diffusion preventive film is provided with function to prevent a principal constituent element in said matrix material from diffusing into said releasing film.

2. The press die according to claim 1, wherein said diffusion preventive film is constituted by a high-melting point metal having a melting point, as represented by centigrade, of not less than 2.6 times as high as the forming temperature of glass.

3. The press die according to claim 2, wherein said diffusion preventive film is constituted by a plurality of layers differing in composition from each other.

4. The press die according to claim 2, wherein said matrix material is constituted by a sintered body of tungsten carbide (WC), and said diffusion preventive film is constituted by at least one kind of metal selected from the group consisting of Ta, Nb, Re, Os, Ru, Ir, Zr, Mo, Rh and Hf.

5. A press die for press forming of glass, which comprises:
a matrix body; and
a releasing film covering the surface of said matrix body;
wherein said releasing film is constituted by a high-melting point metal having a melting point, as represented by centigrade, of not less than 2.6 times as high as the forming temperature of glass.

6. The press die according to claim 5, wherein said releasing film is constituted by a plurality of layers differing in composition from each other.

7. The press die according to claim 5, wherein said matrix material is constituted by a sintered body of tungsten carbide (WC), and said releasing film is constituted by at least one kind of metal selected from the group consisting of Ta, Nb, Re, Os, Ru, Ir, Zr, Mo, Rh and Hf.
